(19) United States
(12) Patent Application Publication
(10) Pub. No.: US 2025/0075630 A1
(43) Pub. Date: Mar. 6, 2025

(54) System And Method For Monitoring Rotating Member

(71) Applicant: ODYSIGHT.AI LTD., Omer (IL)

(72) Inventors: Amir GOVRIN, Ramat Gan (IL); Hasan ABU EL RAB, Baqa El-Ghabiyye (IL)

(21) Appl. No.: 18/818,782

(22) Filed: Aug. 29, 2024

Related U.S. Application Data
(60) Provisional application No. 63/535,677, filed on Aug. 31, 2023.

(51) Int. Cl. F01D 21/00; G06V 20/64

(52) U.S. Cl. CPC F01D 21/003; G06V 20/64; F05D 2260/80; F05D 2270/804

(57) ABSTRACT

A system for monitoring a rotating impeller is described. The system comprising: at least one optical imager positioned at a selected distance from the rotating impeller to provide one or more images of the rotating impeller; and a controller operatively connected to said at least one optical imager and configured to operate the at least one optical imager for collecting one or more images of said rotating impeller, and to enable analysis of the one or more images for providing indication of one or more health indicators of said rotating impeller.

### CROSS REFERENCE TO RELATED APPLICATIONS

This application claims the benefit of priority of U.S. Provisional Patent Application No. 63/535,677, filed Aug. 31, 2023, the contents of which are incorporated herein by reference in their entirety.

### TECHNOLOGICAL FIELD

The present disclosure is in the field of monitoring health of operating mechanisms and specifically related to monitoring health of rotating member such as turbine, turbo condenser and the like.

### BACKGROUND

Rotating members, such as turbines, are used in various systems. For example, rotating turbines, impellers or fans are used in jet engines, turbo condenser for internal combustion and other engines, and various other applications.

In certain systems, a rotating member may rotate at very high speed and may withstand high forces due to rotation and compression of gas or liquid by the rotation action.

For example, a turbo or turbocharger unit utilizes a rotating fan compressing high volume of air into an internal combustion engine and thereby enhance engine performance. The turbocharger increases power output of the engine by increasing air volume input into the engine cylinders.

Typical jet engines utilize one or more turbines, typically located at intake port of combustion chamber. Such turbines may spin at very high velocity and operated to compress air into the combustion chamber where it ignites with fuel providing expanding gases that may generate propulsion.

Rotating turbines in turbochargers and/or jet engines may rotate at velocities of 20,000 to 100,000 RPM and at times at higher speeds. At these high rotation speed, a fault and/or structural failure within the rotating member of the turbine may cause excessive damage.

### GENERAL DESCRIPTION

There is a need in the art for a system and technique for monitoring high-speed rotating members/impeller. The present disclosure provides a system configuration, technique for operation and general method for monitoring status of a rotating turbine/impeller during operation and providing output data indicative of status of the rotating member. Generally, there are various situations where fault and/or failure of a rotating impeller may manifest. For example, a selected and not exhaustive list of modes of failure may include rotation speed variation (e.g., uncontrolled high rotation speed), impeller out of balance, impeller off-center, as well as general conditions such as rust and/or corrosion of the impeller.

The present disclosure provides a monitoring system, utilizing one or more optical imagers, located at a selected location, and configured for collecting image data of the impeller during rotation thereof. In some other embodiments, the one or more optical imagers may be located at an intake side of a rotating impeller. In some embodiments, the one or more optical imagers may be placed with optical axis thereof being substantially parallel with rotation axis of the impeller. In some embodiments, “substantially parallel” encompasses variation in location of the optical imager of about 10% of impeller diameter, or about 20% of impeller diameter. In some embodiments, the optical axis of the optical imager may vary in angle with respect to rotation axis of the rotating impeller, allowing variation in angular relation of up to 30° or up to 20°. In some embodiments, the optical axis may also coincide with rotation axis of the impeller, providing generally symmetric image data of at least a portion of the impeller, where rotation axis may be generally at central location of the collected image data. In some embodiments, the one or more optical imagers are configured with field of view that includes center of the impeller, i.e., rotation axis thereof, and at least a part of the impeller active region.

In some embodiments, the one or more optical imagers may be located at outtake end of the rotating impeller. This location of the one or more optical imagers may reduce interference with flow of intake of the impeller. However, this location may be limited due to environmental consideration such as high temperatures that might be at outtake of the impeller, and may limit functionality and/or cause damage to the one or more optical imagers.

The optical imager may be operated by a controller, configured to operate for collecting one or more images of the rotating impeller using selected imaging conditions, and to provide the collected image data for processing. In some embodiments, the controller may comprise one or more processors and perform local processing of the image data. Alternatively, the controller may store and/or transmit the collected image data for remote processing, e.g., by one or more remote processors and/or using cloud processing.

Generally, for obtaining sharp images of a fast-rotating member such as an impeller or turbine, the exposure duration of the optical imager needs to be very short. The inventors of the present application have found that this requirement can be overcome using a suitable lighting arrangement comprising one or more illumination sources or light sources (e.g., LED light sources) configured to provide pulsed-like illumination, or strobing illumination, optionally synchronized with operation of the optical imager. The lighting arrangement may comprise one or more illumination sources arranged at a selected distance around periphery of the impeller housing (or housing of the rotating member to be inspected) and configured to illuminate the impeller using selected illumination pattern.

In some embodiments, a controller may be operatively connected to the at least one optical imager and/or the lighting arrangement and configured to operate them in synchronization to collect one or more images having selected exposure duration. In this connection the term exposure duration may be understood as relating to duration of exposure determined by the optical imager, duration of common exposure of the optical imager while lighting arrangement provides illumination of the impeller, or the short of the two.

The controller may provide output data comprising one or more images of the rotating member, and/or respective data on exposure duration for further processing or imaging. In some embodiments, the controller may comprise one or more processors and memory and configured for processing the one or more images and determine one or more health indicators indicative of condition of the rotating impeller.

In some embodiments, as indicated above, the monitoring system may comprise an optical imager mounted at a selected distance from the rotating impeller, substantially along axis of rotation, and oriented for imaging at least a part of the rotating impeller. In some embodiments, the optical sensor is positioned at the intake side of the impeller. In such embodiments, the at least one optical imager may comprise a housing having a generally aerodynamic structure to reduce disturbance of the optical imager to flow of air or any other gas or fluid intake by the rotating impeller. The system may further comprise a lighting arrangement comprising one or more illumination sources or light sources positioned at a selected distance to illuminate the rotating impeller with a selected illumination pattern. Optionally, the one or more light sources may comprise one or more light sources positioned in close proximity to the optical sensor. In other cases, for example in order to reduce disturbance of the light source to flow of fluid at the intake side of the impeller, one or more light sources are positioned around a periphery of the rotating impeller. Further, the system may comprise a controller configured for operating the at least one optical imager and optionally the lighting arrangement, and to provide image data indicative of said rotating impeller.

Further, the controller may comprise, or be associated with one or more processors and memory unit and configured for processing the image data and determining one or more health indicators of the rotating impeller. In some embodiments, the controller may operate as a processing unit being associated with the monitoring system or separate therefrom. The one or more health indicators may include data one or more impeller parameters including for example: rotation speed and/or variation thereof, impeller balance (e.g., defined by rotation axis and/or center of mass), impeller center location with respect to rotation axis, as well as general conditions such as rust and/or corrosion of the impeller.

According to some embodiments of the present disclosure there is provided a method for processing one or more images of a rotating impeller (rotating member) to provide one or more output health indicators of the rotating impeller. Such one or more health indicators may relate to indication of possible failure modes of the impeller and trend of failure modes.

Further in accordance with embodiments of the description, the monitoring system may be operated for determining potential faults associated with failure modes and optionally also trend of determined failure modes.

As used herein, according to some embodiments, the term “fault” may refer to an anomaly or undesired effect or process in the impeller and/or one or more associated elements that may or may not develop into a failure. A fault may require follow-up, for example to analyze whether any components should be adjusted, repaired, or replaced.

According to some embodiments, the fault may include, among others, a change in rotation speed, a change in relation between rotation speed and desired rotation speed, a change in impeller center location, a decentration of the impeller, a level of balance of the impeller, a lack of alignment between elements, one or more visual features of the impeller such as rust, corrosion, a crack, crack propagation, a fracture, a visual defect, bending, wear, leakage, a change in color, a change in appearance, change in pattern and the like, or any combination thereof.

According to some embodiments of the present disclosure, the term “failure” may refer to any problem that may cause the impeller and/or one or more associated elements to not operate as intended. In some cases, a failure may disable the impeller or even pose a danger to a mechanism or user.

The term “failure mode” according to some embodiments may relate to any manner in which a fault or failure may occur, such as lack of alignment, change in rotation speed, out of balance, off-center, structural deformation, surface deformation, a crack, crack propagation, a defect, bending, wear, corrosion, leakage, a change in color, a change in appearance, turbulence, and the like, or any combination thereof. It is appreciated that an impeller and its associated elements may be subject to a plurality of failure modes, related to different characteristics or functionalities thereof.

Further, the terms “fault trend”, “fault deterioration trend”, “trend of failure mode” or the like according to some embodiments is to be widely construed to cover any behavior over time of a fault, or a failure mode, when or under what circumstances the fault will turn into a failure. The trend is optionally associated with additional circumstances such as environmental conditions, usage characteristics of the device or impeller, characteristics of a user of a device, or the like. In some embodiments, the system may further determine fault severity, relating to an “amount” of the fault in a part, or how far toward failure is the fault's progression. Fault severity may be minor, small, medium, large, critical etc. Optionally, fault severity may be classified using numerical values, such as a value between 1-10 etc. in other embodiments, fault severity may be classified using color classification, e.g., red standing for severe fault, green for a minor yet uncritical fault, yellow standing for intermediate classifications.

Accordingly, determining a fault trend may be used to determine when and under what operation type and/or environmental parameters a failure may occur. This may be used to calculate and anticipate when a failure may happen and optionally generate alert prior to occurrence of a failure and/or providing a maintenance schedule to prevent a failure. Further, certain faults may not directly relate to expected failure, but indicate general state of the system providing an indication on health of the system and/or on environmental parameters causing the fault.

Thus, according to a broad aspect of embodiments of the present disclosure there is provided a system for monitoring a rotating impeller, the system comprising:
at least one optical imager positioned at a selected distance from the rotating impeller to provide one or more images of the rotating impeller; and
a controller operatively connected to said at least one optical imager and configured to operate the at least one optical imager for collecting one or more images of said rotating impeller, to enable analysis of the one or more images for providing indication of one or more health indicators of said rotating impeller.

According to some embodiments, the at least one optical imager is positioned at intake side of said rotating impeller.

According to some embodiments, the at least one optical imager comprises an aerodynamic housing to reduce disturbance to air flow.

According to some embodiments, the at least one optical imager is positioned with optical axis thereof substantially centered with respect to rotation axis of said impeller.

According to some embodiments, field of view of said at least one optical imager is substantially centered on rotation axis of said impeller.

According to some embodiments, the at least one optical imager is operable with frame rate of up to 240 frames per second.

According to some embodiments, the at least one optical imager is operable with frame rate above 240 frames per second.

According to some embodiments, the system may further comprise a mounting arrangement for mounting of said at least one imager at selected location with respect to said impeller.

According to some embodiments, the controller may comprise, or be connectable to, at least one processor and memory circuitry configured for receiving and processing said one or more images and determining said one or more health indicators of said rotating impeller.

According to some embodiments, the system may further comprise a lighting arrangement comprises one or more light sources arranged along peripheral housing of said impeller at a selected distance from the rotating impeller, said lighting arrangement is connectable to said controller and configured to be operable to provide strobing illumination of selected pulse duration, thereby determining said selected exposure duration for collection of said one or more images.

According to some embodiments, the lighting arrangement comprises one or more strobe illumination sources.

According to some embodiments, the one or more strobe illumination sources have turn-on time below 100 nanoseconds.

According to some embodiments, the one or more strobe illumination sources have turn-on time below 10 nanoseconds.

According to some embodiments, the controller is adapted for controlling strobing pulse duration of the lighting arrangement to provide imaging conditions for detection of one or more parameters of said rotating impeller.

According to some embodiments, the controller is adapted for operating in a rotating frequency (rotation speed) mode comprising operating said lighting arrangement to provide a first strobing pulse duration resulting in a selected level of blurring in collected images and to determine rotation speed/frequency of said rotating impeller in accordance with length of blurred features of said impeller.

According to some embodiments, the controller is adapted to determine rotation speed/frequency based on a relation between duration of illumination pulse and angular range of blurred features in one or more collected images of said rotating impeller.

According to some embodiments, the controller is adapted to determine said first strobing pulse duration in accordance with blur level of one or more features in one or more collected images, providing that blur level being associated with a rotation angle β<360°.

According to some embodiments, the controller is adapted for operating in a impeller balance mode comprising operating said lighting arrangement to provide a second strobing pulse duration resulting in collection of one or more substantially sharp images, and for processing said one or more substantially sharp images to determine misalignment level of said rotating impeller. In some embodiments, substantially sharp images relate to images having sharpness sufficient for distinguishing three or more features on said rotating impeller.

According to some embodiments, the processing comprises determining three or more reference indicators of said rotating impeller in said one or more collected images, and determining center of rotation of said impeller in accordance with location of said three or more reference indicators in said one or more collected images.

According to some embodiments, the controller is adapted for operating in an impeller analysis mode comprising processing one or more collected images to determine one or more visual parameters of said rotating impeller.

According to some embodiments, the one or more visual parameters comprise detection of at least one of rust and corrosion of said rotating impeller.

According to one other broad aspect of embodiments of the present disclosure there is provided a processing unit comprising at least one processor and memory circuitry configured for processing one or more images of at least a portion of a rotating impeller and determining one or more health indicators of said rotating impeller; wherein said one or more health indicators comprise indication one or more failure modes or trend of failure modes of the impeller.

According to some embodiments, the one or more failure modes or trend of failure comprise at least one of: a change in rotation speed, a change in relation between rotation speed and desired rotation speed, a change in impeller center location, a decentration of the impeller, a level of balance of the impeller, a lack of alignment between elements, one or more visual features of the impeller such as rust, corrosion, a crack, crack propagation, a fracture, a visual defect, bending, wear, leakage, a change in color, a change in appearance, change in pattern.

According to some embodiments, processing said one or more images comprises utilizing data on exposure duration of said one or more images.

According to some embodiments, the processing unit may be configured for transmitting operative instructions for operation of a lighting arrangement to provide selected pulse duration of strobing illumination determining said exposure duration.

According to some embodiments, said processing comprising determining rotation speed of said rotating impeller based on a relation between duration of illumination pulse and length of blurred features in one or more images of said rotating impeller.

According to some embodiments, said processing may further comprise determining a relation between rotation speed of said impeller and desired rotation speed of the impeller, and generating an output indicator if said relation exceeds predetermine threshold.

According to some embodiments, said processing may comprise determining a relation between center of said impeller and axis of rotation thereof, and generating an output indicator on said relative distance. According to some embodiments, said determining a relation between center of said impeller and axis of rotation thereof comprises determining three or more reference indicators of said rotating impeller in said one or more images, and determining alignment of center of rotation of said impeller in accordance with location of said three or more reference indicators in said one or more images. According to some embodiments, said determining alignment of center of rotation comprises determining center location of a circle determining by said three or more reference indicators in one or more images and determining relative location of said center location and location of axis of said impeller.

According to some embodiments, said processing may further comprise obtaining one or more images of a first exposure duration, and processing said one or more images to determining angular range of blurring of one or more features of the impeller, determining a second exposure duration in accordance with desired angular range of blurring of said one or more features and generating operational instruction to a corresponding monitoring unit for collecting one or more images with said second exposure duration.

According to some embodiments, exposure duration of said one or more images may be selected to provide angular range of blurring of one or more features of the impeller within a range between 0.01° and a selected maximal blurring range. According to some embodiments, the selected maximal blurring range is in the range between 1° and 359°. According to some embodiments, the selected maximal blurring range is in the range between 90° and 180°.

According to yet another broad aspect of embodiments of the present disclosure there is provided a method for monitoring a rotating impeller, comprising:
a. providing one or more images of a rotating impeller, said one or more images being collected with selected exposure duration;
b. processing said one or more images and determining one or more health indicators of said rotating impeller.

According to some embodiments, said processing of said one or more images comprises utilizing data on exposure duration of said one or more images.

According to some embodiments, said exposure duration is determined by pulse duration of strobing illumination.

According to some embodiments, the method may comprise determining rotation speed/frequency of said rotating impeller based on a relation between duration of illumination pulse and length of blurred features in one or more images of said rotating impeller.

According to some embodiments, the method may further comprise determining a relation between rotation speed/frequency of said impeller and desired rotation speed/frequency of the impeller, and generating an output indicator if said relation exceeds predetermine threshold.

According to some embodiments, the processing comprises determining a relation between center of said impeller and axis of rotation thereof, and generating an output indicator on said relative distance.

According to some embodiments, said determining a relation between center of said impeller and axis of rotation thereof comprises determining three or more reference indicators of said rotating impeller in said one or more images, and determining alignment of center of rotation of said impeller in accordance with location of said three or more reference indicators in said one or more images.

According to some embodiments, said determining alignment of center of rotation comprises determining center location of a circle determining by said three or more reference indicators in one or more images and determining relative location of said center location and location of axis of said impeller.

According to some embodiments, the method may further comprise providing one or more images of a first exposure duration, and processing said one or more images to determining angular range of blurring of one or more features of the impeller, and selecting a second exposure duration in accordance with desired angular range of blurring of said one or more features.

According to some embodiments, said elected exposure duration is selected to provide angular range of blurring of one or more features of the impeller within a range between 0.01° and a selected maximal blurring range.

According to some embodiments, said selected maximal blurring range is in the range between 1° and 359°. According to some embodiments, said selected maximal blurring range is in the range between 90° and 180°, or between 10° and 90°.

According to yet another broad aspect of embodiments of the present disclosure there is provided a method for monitoring a rotating impeller comprising:
a. operating at least one optical imager positioned for imaging said rotating impeller, and a lighting arrangement positioned to illuminate said rotating impeller in synchronization to provide one or more images of selected exposure duration;
b. processing said one or more images and determining in accordance with exposure duration thereof one or more health indicators of said rotating impeller.

According to some embodiments, said at least one optical imager is positioned at a selected distance from the rotating impeller where optical axis of said optical imager substantially coincides with axis of rotation of said rotating impeller.

According to some embodiments, said lighting arrangement is position around periphery of said rotating impeller and configured to provide strobing illumination of selected strobing pulse duration.

According to some embodiments, the method may further comprise controlling strobing pulse duration of the lighting arrangement to provide selected exposure duration for imaging of said rotating impeller.

According to some embodiments, the method may further comprise operating said lighting arrangement to provide a first strobing pulse duration resulting in a selected level of blur in received images and to determine rotation speed/frequency of said rotating impeller in accordance with length of blurred features of said impeller.

According to some embodiments, the method may further comprise determining rotation speed/frequency of said rotating impeller based on a relation between duration of illumination pulse and length of blurred features in one or more received images of said rotating impeller.

According to some embodiments, the method may further comprise determining said first strobing pulse duration in accordance with blur level of one or more features in one or more received images, providing that blur level being associated with a rotation angle β<360°.

According to some embodiments, the method may further comprise operating said lighting arrangement to provide a second strobing pulse duration resulting in collection of one or more substantially sharp images, and for processing said one or more substantially sharp images to determine misalignment level of said rotating impeller. In some embodiments, substantially sharp images relate to images having sharpness sufficient for distinguishing three or more features on said rotating impeller.

According to some embodiments, said processing comprises determining three or more reference indicators of said rotating impeller in said one or more received images, and determining center of rotation of said impeller in accordance with location of said three or more reference indicators in said one or more received images.

According to some embodiments, the method may further comprise processing one or more received images to determine one or more visual parameters of said rotating impeller.

According to some embodiments, said one or more visual parameters comprise detection of at least one of rust and corrosion of said rotating impeller.

According to some embodiments, the method may further comprise providing at least one optical imager at input side of said rotating impeller.

According to some embodiments, the method may further comprise providing said at least one imager in an aerodynamic housing to reduce air turbulence.

In some further embodiments, the present disclosure provides a software product, e.g., computer program, implements on a computer readable medium and comprising computer readable instructions that when executed by one or more processors, cause the one or more processors to operate in accordance with the method described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates schematically a monitoring system according to some embodiments of the present disclosure;

FIG. 2 illustrates a processing unit configured to determining one or more health indicators according to some embodiments of the present disclosure;

FIG. 3 illustrates schematically a monitoring system according to some additional embodiments of the present disclosure;

FIG. 4A exemplifies regions of an impeller and of collected images according to some embodiments of the present disclosure;

FIG. 4B exemplifies selected structure and respective disturbance to flow as known in the art;

FIG. 5 exemplifies a method of monitoring a rotating impeller according to some embodiments of the present disclosure;

FIGS. 6A to 6D exemplify a method for determining rotation speed of a rotating impeller according to some embodiments of the present disclosure, FIG. 6A exemplifies a method, and FIGS. 6B to 6D exemplify blurring levels in collected images;

FIGS. 7A to 7E exemplify determining central location, and deviation from the canter in a rotating impeller according to some embodiments of the present disclosure, FIG. 7A illustrates a method actions, FIG. 7B exemplifies center of circle, and FIGS. 7C to 7E exemplify variation in center of circle and determining center of an impeller according to some embodiments of the present disclosure; and

FIG. 8 exemplifies a method for determining one or more visual parameters and deviation therefrom according to some embodiments of the present disclosure.

### DETAILED DESCRIPTION OF EMBODIMENTS

As indicated above, the present disclosure provides a system and respective method for monitoring a rotating member, such as turbine, turbo condenser, jet engine condenser etc. The rotating member according to some embodiments of the invention, also referred to herein at times as impeller, relates to a rotating element equipped with vanes or blades and configured to pump fluid, typically air or gas, from a cold side or intake thereof toward a hot side, or outtake thereof.

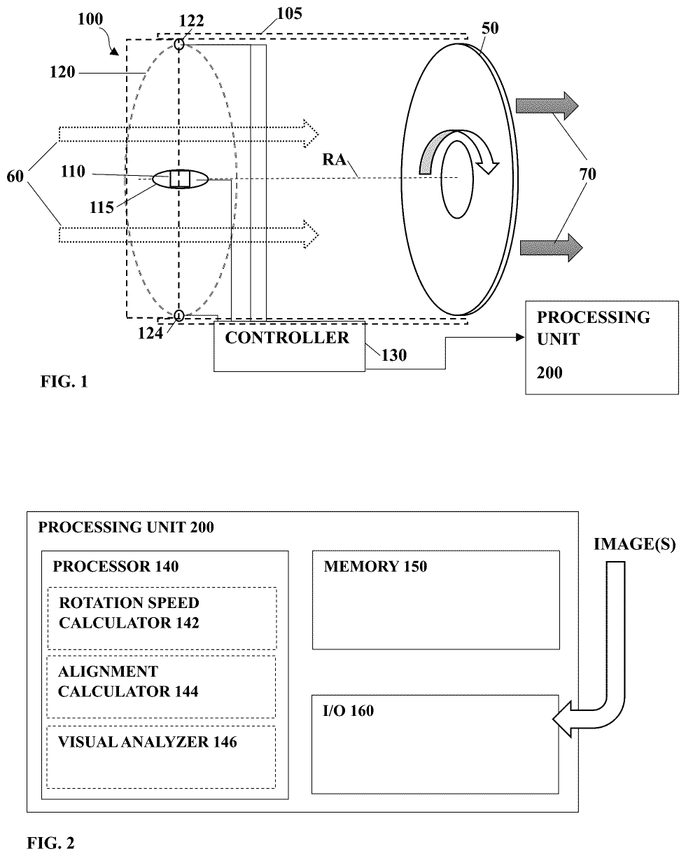

Reference is made to FIG. 1 schematically illustrating a monitoring system 100 for monitoring a rotating impeller 50 according to some embodiments of the invention. optionally, the impeller 50 operates for pumping gas or fluid providing flow 60 from an intake side of the impeller 50 generating outtake flow 70 at an outtake side thereof.

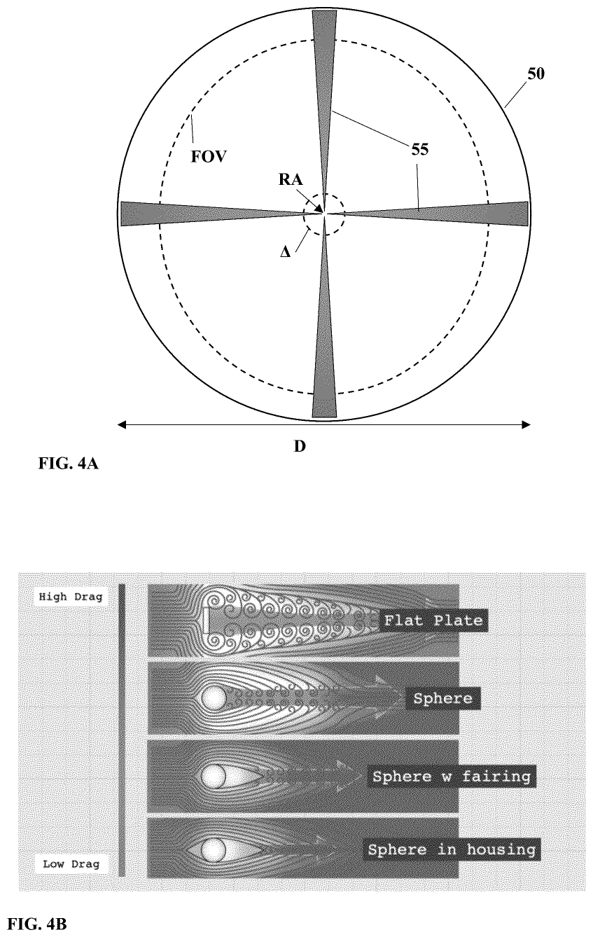

According to some embodiments, the system 100 includes at least one optical imager 110, positioned at a selected distance from the rotating impeller 50, and a controller 130 connected to the at least one optical imager 110 and configured to operate the optical imager 110 for collecting one or more images of at least a part of the rotating impeller 50, optionally at selected exposure duration. The controller 130 may be configured to transmit the collected one or more images to a processing unit or remote processing utility 200, e.g., using one or more processor, cloud processing, or to a storage utility. As illustrated in FIG. 1, the optical imager 110 may be placed substantially along rotation axis RA of the rotating impeller, having optical axis of the imager substantially parallel to the rotation axis RA. According to some embodiments, certain variation in location and/or angular orientation of the optical imager may be provided as exemplified in FIG. 3 below. Optionally, optical imager may be associated with, or placed within an acrodynamic housing 115, having a generally smooth surface and configured to reduce disturbance to flow 60.

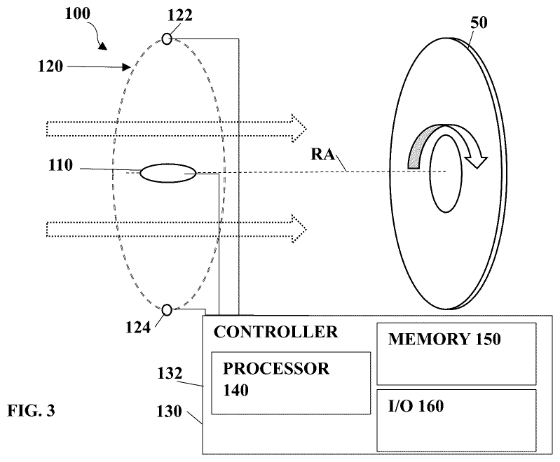

In some embodiments of the present disclosure there is provided a processing unit. FIG. 2 illustrates processing unit 200 configured and operable for receiving and/or obtaining one or more images of a rotating impeller and for determining one or more health indicators of the rotating impeller based on processing of the one or more images. The processing unit 200 may include one or more processors 140, memory 150, and I/O interface 160, and may be adapted to process the collected images fully or partially and to provide output data including one or more health indicators of a rotating impeller 50. The processing unit 200 may be connectable to a monitoring unit 100 via wired or wireless communication and/or may obtain one or more images of an impeller from a local or remote storage utility. The processing unit 200 may operate for processing the one or more images in accordance with one or more of the techniques described herein.

In some embodiments, the one or more processors 140 may operate in accordance with computer readable instructions provided via the I/O interface 160 and/or stored in the memory 150. The one or more processors may operate one or more software and/oc hardware modules for performing selected processing tasks as described herein below. For example, the one or more processors may include a rotation speed calculator 142 adapted for determining impeller rotation speed and/or compare determined rotation speed and desired rotation speed as described below. Additionally, or alternatively the one or more processors may include an alignment calculator 144 adapted for determining center location of the impeller and alignment thereof as described below. Further additionally, or alternatively the one or more processors may include a visual analyzer 146 adapted for processing the one or more images for visual parameters of the impeller as described further below. The processing unit 200 may operate for processing one or more images, determine one or more health indicators of the rotating impeller, and generate output signals or alerts to be transmitted to a user interface and/or other indication utilities, e.g., via the I/O 160.

Referring back to FIG. 1, in some embodiments, optical imager 110 may include one or more detector arrays and respective imaging optics. For example, optical imager 110 may utilize a detector array including one or more of a charge-coupled device (CCD), a light-emitting diode (LED) and a complementary metal-oxide-semiconductor (CMOS) sensor (or an active-pixel sensor), a photodetector (e.g., IR sensor, visible light senor, UV sensor), distance measurement sensor (e.g., Lidar). In addition, optical imager 110 may include one or more lenses selected in accordance with desired wavelength range for imaging, one or more apertures, prisms, or any other optical element that may be used for operation of an optical imager configured for collecting one or more images of a scene.

Additionally, system 100 may also include a lighting arrangement 120, including one or more light sources, exemplified by light sources 122 and 124 in FIG. 1. The one or more light sources of lighting arrangement 120 are configured to illuminate the rotating impeller 50 using selected illumination pattern, and may utilize strobing illumination pattern of selected pulse length and repetition rate. In some embodiments, the one of more light sources may be attached to the optical imager 110 (e.g., within common housing 115). In some other embodiments, the one or more light sources may be placed at a selected distance from the optical imager 110, thereby potentially reducing size of housing 115 to reduce disturbance to fluid intake. In some preferred embodiments the one or more light sources of lighting arrangement 120 may be arranged around periphery of the rotating impeller 50, at a selected distance therefrom. Optionally illumination sources 120 are positioned at a distance being similar to distance of the optical imager, further therefrom or closer to the rotating impeller 50, depending on the specific imaging requirements.

In some embodiments, system 100 may be mounted or mountable on a frame 105, configured to hold at least one optical imager 110 and optionally also lighting arrangement 120 at selected positions, and enabling to place the monitoring system at a selected distance from the rotating impeller 50. Frame 105 may be formed of metallic materials, alloys, polymers, wood, or any other material suitable for holding monitoring system 100 in place. The frame 105 may be configured to allow selective placement of the monitoring system 100 at a selected distance from the rotating impeller 50, selected in accordance with field of view of one or more optical imagers 110 for collecting images of at least a portion of the rotating impeller. In some embodiments the at least one optical imager 110 and/or the lighting arrangement 120 may be mounted or mountable on an existing frame, such as a frame holding the rotating impeller 50.

In some further embodiments, frame 105 may be configured to be mounted on a larger system that generally includes rotating impeller 50. For example, frame 105 may be configured to be mounted on a jet engine for monitoring intake turbine of the jet engine. In other examples, the frame may include mounting arrangement for selectively attaching monitoring system 100 to one or more selected systems that include one or more rotating impellers 50, to provide monitoring during online and/or offline operation.

Monitoring system 100 is generally configured to collect one or more images of rotating member/impeller, to thereby enable determining one of more health indicators of the rotating impeller. Rotating impeller 50 may generally rotate at a very high rotation speed. For example, rotating impeller 50 may rotate at any selected speed, for example rotating impeller may rotate at speed of 5,000, 10,000, 20,000 round per minute (RPM), 100,000 RPM or at times intermediate or greater speed. Typically, at these high rotation speed, a very fast camera is needed for collection of sufficiently sharp image data enabling to determining impeller features. The inventors of the present application have found that the monitoring system 100 of embodiments of the present disclosure may be operable using typical optical imagers known in the art. For example, an optical imager according to embodiments of the invention may operate with frame rate of up to 240 frames per second (FPS), and exposure duration of about 2-4 milliseconds, in some embodiments the optical imager may operate at frame rate of 30 FPS, providing exposure duration of about 16.667 milliseconds. This may be achieved using a lighting arrangement operable with strobing illumination and synchronization between strobing illumination of the lighting arrangement and frame rate of the optical imager. Alternatively, according to some embodiments, the monitoring system of the present disclosure may utilize any optical imager including optical imager having frame rate above 240 frames per second, and corresponding exposure duration of 2 millisecond or shorter, in some embodiments, effective exposure duration may be a few hundreds of microseconds.

Accordingly, lighting arrangement 120 may include one or more light sources such as light sources 122 and 124. The one or more light sources may be any type of light source capable of emitting optical radiation of a selected wavelength range, selected in accordance with optical imager's collection spectrum. For example, in some embodiments, one or more light sources 122 and 124 may include one or more LED light sources. The light sources may utilize monochromatic LED, RGB LED, infrared (IR) LED, UV, or other suitable light sources, depending on specific requirements of the impeller and its surroundings. For example, to provide white light illumination, RGB LED may be preferred over blue LED coated with fluorescent material, due to the slow turn off time of the fluorescent material. In addition, UV illumination may enable view of sparks which are not always identifiable with other illumination sources.

As indicated above, when monitoring a turbine, turbo, or jet engine, which may typically rotates at tens of thousands of RPM, exposure duration of imaging may be determined, for the purposes of embodiments of the present disclosure, by effective collection duration, being the common time where optical imager 110 is operated for collecting radiation arriving from the scene (the rotating impeller) and time where the lighting arrangement 120 (when used) is operated for illuminating the scene (the rotating impeller). In some embodiments, as indicated above, the lighting arrangement 120 may be operable to provide strobing illumination, generating short bursts of light (e.g., in the order of milliseconds, tenths of milliseconds, or less). Proper synchronization between operation of the optical imager 110 and the lighting arrangement 120 enable controlling of exposure duration and providing selective sharpness levels of the collected images.

Providing sharp images of rotating member, such as impeller 50, generally required image collection with very short exposure time, such that the impeller does not move much during collection of the image data. One way to obtain short exposure time is the use of high-speed camera, which are generally large and costly. An additional way to obtain short exposure duration is based on controlling the illumination of the scene. More specifically, while the optical imager may operate with typical, and relatively long, exposure duration, a lighting arrangement is used to provide illumination of the impeller with short pulses, such that only during the illumination pulse, the optical imager collects light, and the effective exposure duration is sufficiently short. To this end, operation time of the one or more light sources of lighting arrangement 120 may preferably be short. For example, in some embodiments, light sources 122 and 124 of lighting arrangement may have turn-on time of 1 nanosecond to tens of nanoseconds for larger LEDs. However, in some embodiments, light sources having turn on time of about 100-400 nanoseconds may be used. To this end, according to some embodiments of the present disclosure, operation of the optical imager 110 and the lighting arrangement may be synchronized to provide selectively short overlap period between exposure time of the optical imager 110 and illumination time of the lighting arrangement 120.

Turn off time of typical light sources may be slower than the turn-on time and may be in the range of tens of nanoseconds. The lighting arrangement according to embodiments of the invention may thus be operable for providing strobing illumination formed of pulses of tens to a few hundreds of nanoseconds. Accordingly, as described in more detail below, operation of the optical imager and lighting arrangement may provide selective exposure duration, allowing to obtain sharp images and/or selectively blurred images of the rotating impeller.

Additionally, as indicated above, monitoring system 100 may be placed at intake side (e.g., cold side) of the rotating impeller. To avoid interference and obstruction to air flow and air intake of the rotating impeller, optical imager 110 may be placed within an acrodynamic housing 115. Such aerodynamic housing 115 may include generally smooth surfaces and surface curvature allow generally laminar air flow around the housing 115.

As described above, monitoring system 100 exemplified in FIG. 1 is configured for collecting one or more images, allowing monitoring and determining one or more health indicators of a rotating impeller. In some embodiments, of the present disclosure, the monitoring system 100 may also include one or more processors and memory, configured to provide processing of the one or more images and determining one or more health indicators of the rotating impeller 50. FIG. 2 exemplifies a processing unit 200 as described above and FIG. 3 exemplifies monitoring system 100, where the controller 130 further includes one or more processors 140, memory 150, and I/O interface 160, and adapted to process the collected images fully or partially and to provide output data including one or more health indicators of the rotating impeller 50 according to some embodiments of the invention.

As exemplified in FIG. 3. in some embodiments, at least one processor 140 and memory 150 provide together a processor and memory circuitry (PMC) 132 operatively connected to a I/O interface 160. The PMC 132 is configured to provide processing necessary for operating the system as further detailed herein below. The processor 140 of PMC 132 can be configured to execute several functional modules in accordance with computer-readable instructions implemented on a non-transitory computer-readable memory comprised in the PMC. Such functional modules are referred to hereinafter as comprised in the PMC. further, it should be noted that PMC of controller 130 may perform selected processing functions, while transmitting data to one or more remote processors, and/or could processing for certain selected processing functions.

In some embodiments, controller 130 may be adapted to operate the at least one optical imager 110 and optionally also the lighting arrangement 120, for collecting one or more images, using selected effective exposure durations. The controller 130 and/or PMC 132 may operate to process the so-collected one or more images and determine one or more health indicators of the rotating impeller. Such health indicators may relate to one or more possible failure modes of the impeller 50, e.g., including data on rotation speed, and optionally an indication on relation between actual rotation speed and desired rotation speed, data on deviation from rotation axis, imbalance of the rotating impeller, as well as general status data such as indication on rust, corrosion, cracks, fractures, decoloring, etc. as described in more detail further below.

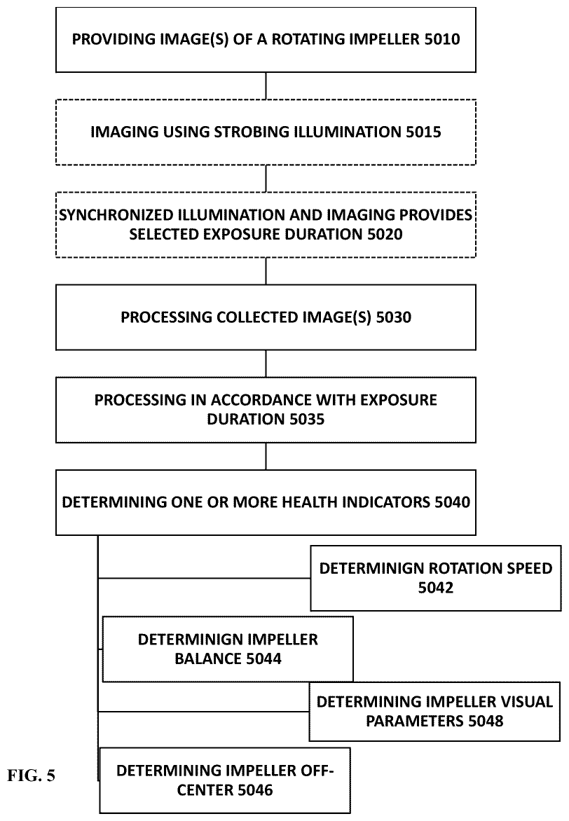

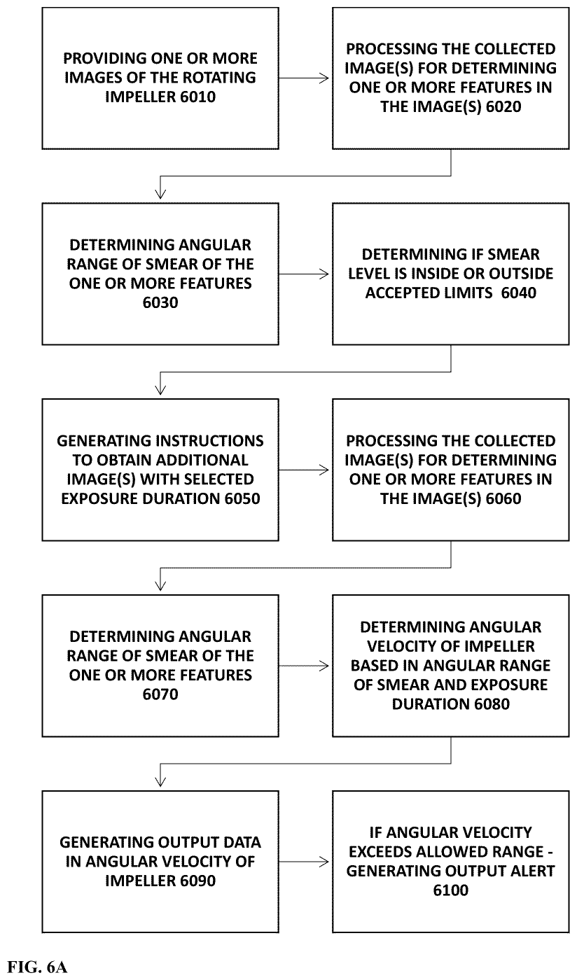

Reference is made to FIG. 4A, schematically illustrating an impeller 50 having diameter D and rotating around rotation axis RA according to some embodiments of the invention. FIG. 4A generally exemplifies field of view FOV of the optical imager 110 according to some embodiments of the present disclosure. In some embodiments of the present disclosure, the optical imager may collect images at a field of view FOV as marked including at least central region and a portion of operation area of the impeller 50. The impeller is exemplified herein using four blades 55. However, it should be understood that the impeller 50 may include any selected number of blades in accordance with specific design of the impeller. In some embodiments of the present disclosure, the optical imager may collect images at a field of view FOV as marked including at least central region and a portion of operation area of the impeller 50. FIG. 3 also illustrated a range A around rotation axis RA. The range A generally indicates allowed range of variation in location of the optical imager with respect to the rotation axis RA of the impeller, and/or allowed angular variation according to some embodiments of the present disclosure. More specifically optical imager 110 may be placed such that optical axis thereof is substantially parallel to rotation axis of the rotating impeller 50. In some embodiments, optical axis of the optical imager 110 may be positioned to substantially coincide with rotation axis of the rotating impeller. As indicated above, in some embodiments the term “substantially parallel” encompasses variation in location of the optical imager of about 10% of impeller diameter, or about 20% of impeller diameter. This is illustrated in FIG. 4A by range A around rotation axis RA of the impeller 50. According to some embodiments, when used with reference to location of optical axis of the at least one optical imager with respect to rotation axis RA of the impeller relates to range A being 20% of impeller diameter, or 10% of impeller diameter. Further, as also indicated above, angular orientation of the optical imager may allow variation of up to 30° or up to 20° with respect to rotation axis RA of the impeller 50, providing that the image field of view includes at least central region of the impeller and a portion of operation area of the impeller 50.

Further, FIG. 4A exemplifies general field of view FOV of at least one optical imager 110. As shown, the optical imager 110 is preferably configured to collect images within a field of view that includes most of the active region of rotating impeller 50. Typically, however, rotating impeller 50 may include a frame (not specifically shown), blocking peripheral parts of the impeller from view of the optical imager 110. For example, field of view FOV of optical imager may preferably include at least 10%, or at least 20%, or at least 30%, or at least 40% or at least 50%, or at least 60%, or at least 70% of diameter of rotating impeller.

Additionally, reference is made to FIG. 4B exemplifying effects of different shapes of blocking elements, e.g., optical imager 110, located within flow of fluid (air, or other gasses). As indicated above, in some embodiments of the present disclosure, the monitoring system 100 may utilize one or more optical imagers 110 located at intake (e.g., cold) side of the rotating impeller 50. This may be a result of high temperatures typical to the outtake (e.g., hot) side of the impeller 50. However, placing of the one or more optical imagers 110 at intake side may disturb air/fluid intake of the impeller and reduce its efficiency and/or load applied thereto by fluid/air flow. Thus, according to some embodiments of the present disclosure, the optical imager 110 may be placed in an aerodynamic housing 115. The effects of various shaped of the housing 115 on intake fluid/air flow are illustrated in FIG. 4B. As shown a flat plate object may cause high turbulence and disturbance to intake flow of the rotating impeller and may reduce its efficiency. A spherical shape of the optical imager may cause less disturbance, and with an addition of fairing the disturbance may be further reduced. The use of aerodynamic housing having front curved end and fairing to provide a smooth and streamline structure with minimal protruding features that may cause disturbance in air flow. Some embodiments of the invention use an aerodynamic housing 115 in order to minimize, or at least reduce interference of the optical imager 110 with intake flow, thereby optionally enabling monitoring of the rotating impeller in real conditions and at times, during actual operation.

Referring back to FIG. 1, a rotating impeller 50, such as used in turbo condenser or other systems may be formed of a rotating member carrying a selected number of blades and configured to push fluid from one side, being intake side or cold side, thereof to another side, being hot or outtake side. The outtake side may, in some configurations, be associated with very hot environment, typically being internal region of an operating system (e.g., engine). The temperatures at the hot side may reach very high temperatures, often exceeding 600° C. or even 1000° C. This extreme heat poses a significant challenge for integrating cameras within the turbo. Accordingly, as discussed above, the monitoring system 100 of embodiments of the present disclosure places the one or more optical imagers 110 and lighting arrangement 120 at the cold side of the impeller to avoid issues associated with excessive heat and enable to maintain camera functionality. In some embodiments, the hot/outtake side of the impeller 50 may have typical operation conditions, and room temperature or generation operation temperature range. In such configurations, the monitoring system may be placed at outtake or intake sides in accordance with system design and additional considerations.

Position of the monitoring system 100, and/or its at least one optical imager 110 in path of intake flow of the rotating impeller may require certain adjustments as described herein. Generally, to obtain clear, uniform, and undistorted images of the impeller, the optical imager(s) is preferably placed to be aligned with rotation axis RA of the impeller such that optical axis of the optical imager, and rotation axis of the impeller are substantially overlapping. In some embodiments, as exemplified in FIG. 4A, certain variation of 20% or 10% of impeller diameter in location of the optical imager may provide sufficient imaging conditions. Further, certain angular variation, typically of up to 20° in angular orientation of the optical imager 110 may provide sufficient imaging conditions. Further, field of view of the optical imager 110 optionally includes impeller rotation center, and rotation center of the impeller is more preferably located around central location of the field of view.

Further, location of the optical imager in path of intake flow may cause obstruction and interference in air supply and consequently degrade turbo performance. Accordingly, in some embodiments, as indicated above, the optical imager 110 may be placed within a housing 115 having aerodynamic shape, e.g., teardrop shape, wing shape, streamlined shape, aerofoil shape, etc. Such smooth housing shape may reduce interference and obstruction to air flow and thus reduce potential effect on impeller performance. Additionally, location and configuration of the lighting arrangement 120 is optionally selected to reduce interference and obstruction to intake flow. The lighting arrangement 120 may be connected to the optical imager and placed within common housing 115 of the optical imager. Alternatively, the lighting arrangement 120 may be separate from the optical imager, as illustrated above. The lighting arrangement 120 may be located on the sides/periphery of the rotating impeller 50, or placed symmetrically along its circumference. This configuration may optionally provide adequate lighting without obstructing field of view of the optical imager, and may provide sufficient illumination for imaging of the impeller while minimizing airflow disturbance as exemplified in FIG. 4B above.

In some embodiments, the use of relatively small optical imager may simplify design of aerodynamic housing 115. Combined with strobing illumination and synchronized operation, the optical imager 110 may be a conventional optical imager having maximal frame rate of 240 or 120 FPS, and/or may utilize rolling shutter, and/or global shutter operation. This is enabled using synchronized strobing illumination by lighting arrangement 120 to provide suitable exposure duration for different imaging conditions.

Operation of the monitoring system 100 and processing of image data collected thereby may provide one or more health indicators of the rotating impeller 50. As indicated above, the processing may be performed by one or more processors 140 or controller 130, or by a remote processing utility including remote computer, cloud processing applications etc. Determining health indicators, and identifying variations in health indicators of the impeller may enable detection of fault, trend of fault and failure mode that may progress toward failure of the impeller.

In some embodiments, not specifically shown, the monitoring system 100 may utilize at least one optical imager 110, and optionally a lighting arrangement 120, located at outtake side of the rotating impeller 50. Position of the monitoring system 100 at outtake side of the impeller may provide similar data on the impeller and may not interfere with intake flow. However, positioning the optical imager and/or lighting arrangement at the outtake side but may require considerations with environmental conditions at the outtake side. For example, the temperature at the outtake side may be high and the optical imager/lighting arrangement should be immune to high temperatures.

Generally, as described above, the monitoring system of embodiments of the present disclosure may be operated for determining potential fault, fault trend, failure mode, and possibility of failure of a rotating impeller.

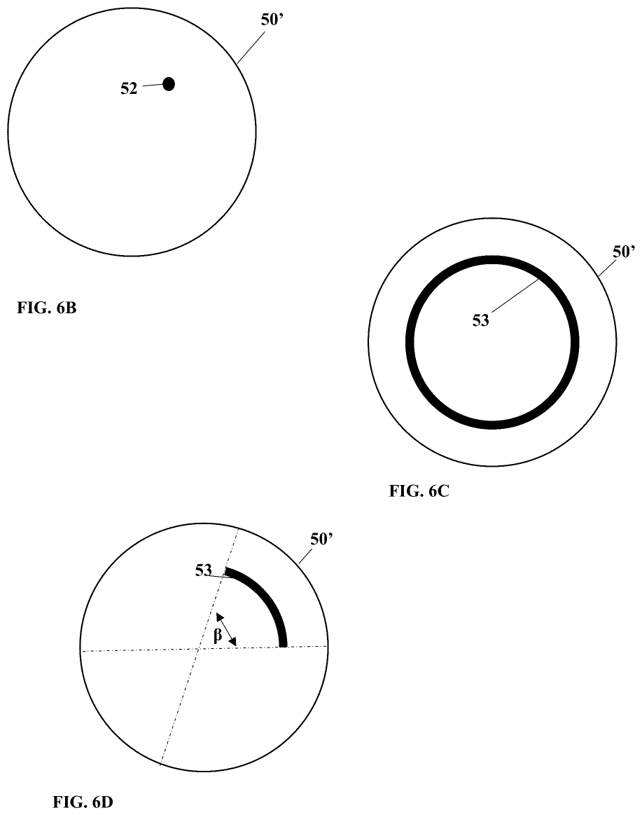

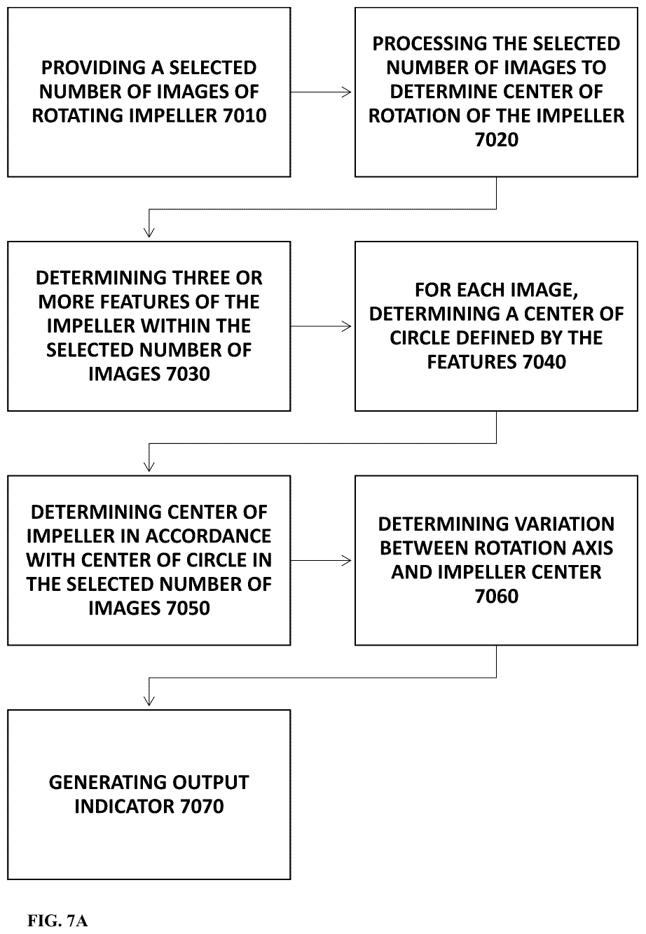

Reference is made to FIG. 5 exemplifying by a way of a block diagram a method for monitoring a rotating impeller according to some embodiments of the present disclosure. As shown, the method according to some embodiments includes providing one or more images of a rotating impeller 5010. In some embodiments, as indicated above, the one or more images may be collected using strobing illumination 5015, that may be synchronized with operation of an optical imager to provide selected exposure duration 5020. Operations 5015 and 5020 are marked in dotted box as these operations are optional, and the method may monitor impeller operation based on image data obtained from a remote optical imager and/or from a storage unit. The method further includes processing the collected image(s) 5030, where the processing may be performed using data on effective exposure duration 5035, and optionally generating output data in request for additional image(s) collected using selected exposure duration. processing of the one or more images is directed at determining and providing output data including one or more health indicators 5040 indicating data on health of the rotating impeller. In some embodiments, the health indicators may include one or more of indication on rotation speed 5042, indication on impeller balance/imbalance 5044, indication of off-center location of the impeller 5046, and/or indication on impeller condition based on visual parameters 5048. Various processing operations for determining the health indicators according to some embodiments of the present disclosure are described with respect to the following FIGS. 6A-6D, 7A-7E and FIG. 8. The exemplary techniques described herein relate to selected embodiments of the present disclosure and are not meant to be limiting in any way.

Reference is made to FIGS. 6A to 6D exemplifying operation in a rotating frequency (rotation speed) mode according to some embodiments of the present disclosure. More specifically, FIGS. 6A to 6D exemplify a technique for determining rotation speed of a rotating impeller according to some embodiments of the present disclosure. FIG. 6A is a block diagram exemplifying method of processing, FIGS. 6B to 6D exemplify schematic image data of the impeller used for determining rotation speed according to the described embodiments.

As shown in FIG. 6A, the method includes providing one or more images of the rotating impeller 6010. The one or more images may be collected using a monitoring system 100 as described above with reference to FIGS. 1 and 3 and may optionally include image(s) of the impeller collected using selected exposure duration and depicting at least a portion of the rotating impeller. To determine data on the rotating impeller, the method includes processing the collected image(s) for determining one or more features in the image(s) 6020. Such features may be any recognizable feature, such as any element or feature of the rotating impeller that can be identified in the image(s) or that a blur level of the feature can be determined. An example of identifying recognizable feature is illustrated in FIG. 6B showing an image of rotation region of the impeller 50′ and marks a selected feature 52 that is generally sharp in the image due to sufficiently short exposure duration. Further, FIG. 6C illustrates an image of the rotating impeller 50′ where blur level of features 53 is high, resulting in mixing of features where it may be impossible to determine angular range of blur of a selected feature. FIG. 6D shows an image where a selected feature 54 has blur level associated with angular range β, where processing of the image enables to determine that a specific feature is blurred within the angular range. Accordingly, the method may include determining angular range of blur of the one or more features 6030, and determining if blur level is inside or outside accepted limits 6040. If blur level is outside accepted limits, e.g., as shown in FIG. 6C, the method may include generating instructions to obtain additional image(s) with selected exposure duration 6050, where the selected exposure duration may be shorter, using selected synchronization and duration in strobing illumination and image collection.

Typically, blur of feature 53 as shown in FIG. 6C is caused by an exposure time that is too long. More specifically, FIG. 6C shows a situation where the exposure time is longer than the time it takes for the object to complete a full rotation. As a result, one identified feature may be mixed with other features reducing the ability to distinguish between them. On the other hand, FIG. 6D shows a situation where the exposure time, determined by combined time of open shutter and illumination is shorter than the time of a full rotation. This provides blur of one or more features along an angle β<360°, allowing processing of the image and determining rotation speed in accordance with a relation between angle β and effective exposure time t as described in more detail below.

In case new image(s) are collected, the method may return to processing the collected image(s) for determining one or more features in the image(s) 6060, and determining angular range of blur of the one or more features 6070. FIG. 6D illustrates angular range β resulting from blur level of a feature of the impeller. Based on angular range of blur of the feature, and effective exposure duration, the method may determine angular velocity of impeller 6080 and optionally generates output data in angular velocity of impeller 6090.

Optionally, following determining angular velocity, or rotation speed, of the impeller the method may further include determining a ratio, or a difference between desired rotation speed and actual rotation speed, and if rotation speed exceed allowed range with respect to desired rotation speed, the method includes generating an output alert 6100.

In some situations, rotating impellers, such as turbo condensers may not rotate at a constant speed. In some embodiments, analysis of rotation may be performed at “slower” rotation times, for example where the turbo motor in a train can be monitored during times when the train slows down before complete stop. This can enable monitoring during rotation speed of between 8-12,000 rpm as opposed to about 25,000 rpm during maximum output operation. However, embodiments of the present disclosure may be implemented at any rotation speed using appropriate strobing light and effective exposure duration.

In some embodiments, determining rotation speed may utilize the above-described method including for example registration of one or more elements on the rotation body of the impeller. The registration can be done in different ways including for example: (i) Identifying and registration of the element while the impeller is static, the detection of whether the impeller is in motion or static can be done by receiving the information from the monitored system or by using a displacement detection algorithm; (ii) Using a high-speed camera (High frame rate) i.e., the exposure time of the shutter should be short enough in relation to the speed of movement so that the resulting image will be sharp and without blurring of the registered element; or (iii) Using strobe lighting to “freeze” the image, the illumination time should be fast enough so that the resulting image will be sharp and without blurring of the registered element. In this connection, details, and technique for identifying and registration of the element is described in PCT/IL2023/050793 assigned to the assignee of the present application and incorporated herein by reference.

As indicated above, if the effective exposure time (associated with collection time of the optical imager and illumination by the lighting arrangement, is longer than the time it takes for the impeller to rotate 360 degrees, the registered element will appear as a blurred 360-degree circle as exemplified in FIG. 6C. Further, this situation may occur if exposure duration is shorter, but blurring of the marked element mixes with other elements in the image.

When the collected image enables detection of recognizable feature with certain angular range β in blurred image, rotation speed of the impeller can be determined in accordance with angular range and exposure duration. For example, Rotation speed may be determined as Rs=(β/360)*(60/t), where Rs is rotation speed in RPM (Revolutions Per Minute), β is the angle covered by the blurred representation of an element in the image in degrees, and t is the exposure duration in Seconds.

For example, calculating the impeller rotation speed based on image collected with a 2-millisecond exposure time, and where the angle of the blurred object's trace in the image is 260 deg provides Rotation speed of Rs=(260/360)*(60/0.002)=21,666 RPM

As indicated above, the determined rotation speed may optionally be compared to desired rotation speed based on input data obtainable from operation system of the rotating impeller, allowing the monitoring system to determine if rotation speed is within allowed limits or not.

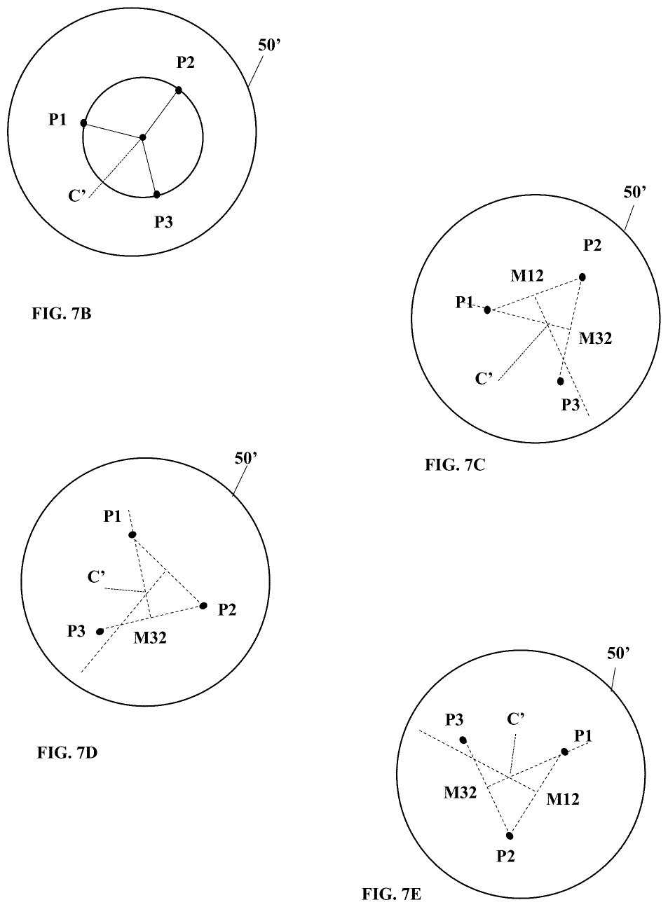

An additional health indicator according to some embodiments of the present disclosure relates to alignment or the rotating impeller, and identifying decentration or misalignment of the impeller. Reference is made to FIGS. 7A to 7E exemplifying operation in an impeller balance mode according to some embodiments of the present disclosure. The figures exemplify a technique for determining decentration or misalignment of the impeller according to some embodiments of the present disclosure. FIG. 7A exemplifies a method in a way of a block diagram, and FIGS. 7B to 7E illustrate exemplary images of the impeller including marking of features and virtual marking exemplifying processing actions according to some embodiments of the present disclosure.

In some exemplary embodiments, detecting misalignment may include processing one or more images and registering one or more selected recognizable features of the impeller, that can be identified in different images. The processing optionally includes determining a distance within the one or more images, between the selected features and a static point in the image, e.g., surrounding of impeller. The distance between the features and the selected static point is expected to change between images in accordance with rotation of the impeller. Accordingly, the processing may include comparing distance variations between the images, with expected distance variations due to rotation, and determining misalignment accordingly.

An additional example of technique for determining decentration of the impeller is exemplified in FIGS. 7A to 7E. FIG. 7A shows a method in a way of a block diagram. Including providing a selected number of images of rotating impeller 7010, and processing the selected number of images to determine center of rotation of the impeller 7020. The processing may include determining three or more features of the impeller within the selected number of images 7030. The collected images are preferably collected using relatively short exposure duration (as defined above) to provide distinguishable features of the impeller within the images. Based on three or more features, the processing may determine a center of circle defined by locations of the features 7040. Given nonspecific selection of features, the center of the circle may or may not be at the center of the impeller. The processing accordingly may compare centers of circles determined in a selected number (typically three or more) of images 7050 and determine canter of the impeller accordingly. Given similar features in each image, the so-determined centers of circles are on similar locations of the impeller, and rotate between images in accordance with impeller rotation. Using the same technique in determining a center of circle defined by three points, the processing may utilize the locations of centers of circles determined in three or more images and determining center of circle defined by the locations of each image center of circle, and determine center location of the impeller. The processing may operate to determine relation between center of the impeller and rotation axis thereof 7060 to determine level of deviation from rotation axis, and to generate a corresponding output indicator 7070.

Further, FIG. 7B illustrates an imager of impeller 50′ and marking of three features detected in the image marked as P1, P2, P3. The center of a circle defined by the features is marked as C′. FIGS. 7C to 7E illustrate three images of impeller 50′ with marked features and exemplify a technique for determining impeller center based on the collected images.

As indicated above, the processing may include registration of 3 points on the image of the impeller 50′ by identifying a physical distinguished element on the impeller itself. Each of the distinguished elements/features has certain coordinates that may be determined within the image frame of reference (e.g., pixel coordinates). In the simple case, the three features are arranged with similar radial locations on the impeller and center of the circle defined thereby is the center of the impeller, i.e., r1=r2=r3. However, to determine that, the processing may generally compare location of so-defined centers in additional images. If rotation of the impeller varies location of the so-defined center, additional processing may be used based on marked C′ location between the images.

Accordingly, as illustrated in FIGS. 7C to 7E, determining a center of a circle defined by the three features on the image may include identifying mid points of two-line segments formed by the three points P1-P3. Accordingly, midpoint M12 is a midpoint of the line connecting P1 and P2, and M23 is the midpoint on the line connecting P2 and P3. Determining the midpoints may use the following equations:

$$\begin{matrix}{X}_{midpoint 1 \_ 2} = ( {x}_{1} + {x}_{2} ) / 2 \\ {Y}_{midpoint 1 \_ 2} = ( {y}_{1} + {y}_{2} ) / 2\end{matrix}$$

where x₁, x₂ and y₁, y₂, are the x- and y-coordinates of P1 and P2 respectively. Similarly, the midpoint of the line segment formed by points (x₂, y₂) and (x₃, y₃), may be defined by the coordinates: (X_{midpoint2_3}, Y_{midpoint2_3}) where:

$$\begin{matrix}{X}_{midpoint 2 \_ 3} = ( {x}_{2} + {x}_{3} ) / 2 \\ {Y}_{midpoint 2 \_ 3} = ( {y}_{2} + {y}_{3} ) / 2\end{matrix}$$

using similar coordinate notations.

To determine the center of the circle, the processing may further determine intersection between perpendicular bisectors of the segments between point P1 and P2, and P2 and P3. In this connection a perpendicular bisector is a line crossing a segment at 90° angle at midpoint of the segment. To determine the perpendicular bisectors the present technique may utilize determining slope of the bisector, given that it passes through midpoint of the determine segments. Accordingly, slope of segment between P1 and P2 may be determined by Slope_{1_2}=(y₂−y₁)/(x₂−x₁), and slope of segment between P2 and P3 may be determined similarly by Slope_{2_3}=(y₃−y₂)/(x₃−x₂). The perpendicular slopes or determined as negative inverse of the slope of the original line given by: Slope_{Per1_2}=−1/Slope_{1_2}, and Slope_{Per2_3}=−1/Slope_{2_3}.

Given the slope and a point the perpendicular bisector passed through, processing according to some embodiments of the present disclosure may define equations of the perpendicular bisectors and identify intersection between them. The equations defining the perpendicular bisectors can be given by:

$$\begin{matrix}{Y}_{{1}_{-} 2} - {Y}_{midpoint 1 \_ 2} = {Slope}_{Per 1\_ 2} * ( X - {X}_{midpoint 1 \_ 2} ) \\ {Y}_{{2}_{-} 3} - {Y}_{midpoint 2 \_ 3} = {Slope}_{Per 2 \_ 3} * ( X - {X}_{midpoint 2 \_ 3} )\end{matrix}$$

Based on the equations of the perpendicular bisectors, location of the intersection between them can be determined by setting the equations equal to each other and solving for X providing x-axis location of center of the circle:

$${X}_{center\_point} = ( {Slope}_{Per 1 \_ 2} * {Y}_{midpoint 1 \_ 2} - {Slope}_{Per 2 \_ 3} * {Y}_{midpoint 2 \_ 3} + {X}_{midpoint 2 \_ 3} - {X}_{midpoint 1 \_ 2} ) / ( {Slope}_{Per 1\_ 2} - {Slope}_{Per 2 \_ 3} )$$

To determine y value of the center of circle, the processing may operate to solve the above linear equations y. This may be done by substituting the calculated x value into one of the perpendicular bisector equations:

$$\begin{matrix}{Y}_{1 \_ 2} - {Y}_{midpoint 1 \_ 2} = {Slope}_{Per 1 \_ 2} * ( X - {X}_{midpoint 1 \_ 2} ) \\ {Y}_{center \_ point} = {Slope}_{Per 1 \_ 2} * ( {X}_{center\_point} - {X}_{midpoint 1 \_ 2} ) + {Y}_{midpoint 1 \_ 2}\end{matrix}$$

Optionally, center of circle C′ may be defined in three images as illustrated in FIGS. 7C to 7E. If the location of center (X_{center_point}, Y_{center_point}) is similar between the figures, this is the center of the impeller 50′. However, if the initial features marked as P1 to P3 have different radial distances from the center of impeller, the so-determined center points may vary between the images. At this point, the processing may proceed by defining the three center points as three locations, and determine a center of the impeller as the center of a circle defined by the three center points. This may be done using similar processing as defined herein above.

The following is an exemplary calculation for determining center of circle defined by given three points: Point 1 (X₁=40, Y₁=12), Point 2 (X₂=80, Y₂=50), and Point 3 (X₃=12, Y₃=55).
a) Find the midpoints of the line segments 1_2 and 2_3:

$$\begin{matrix}Xmidpoint1\_ 2 = ( 40 + 80 ) / 2 = 60 \\ Ymidpoint1\_ 2 = ( 12 + 50 ) / 2 = 31 \\ Xmidpoint2\_ 3 = ( 80 + 12 ) / 2 = 46 \\ Ymidpoint2\_ 3 = ( 50 + 55 ) / 2 = 52.5 \\ Midpoint of 2 \_ 3 : ( ( 40 + 80 ) / 2 , ( 12 + 50 ) / 2 ) = ( 60 , 31 ) \\ Midpoint of 2 \_ 3 : ( ( 80 + 12 ) / 2 , ( 50 + 55 ) / 2 ) = ( 46 , 52.5 )\end{matrix}$$

b) determining the slopes of the line segments 1_2 and 2_3:

$$\begin{matrix}Slope1\_ 2 = ( 50 - 12 ) / ( 80 - 40 ) = 0.9 5. \\ Slope2\_ 3 = ( 55 - 50 ) / ( 12 - 80 ) . \approx - 0. 0735\end{matrix}$$

c) determining of the negative inverse of the slopes value to find the perpendicular slopes:

$$\begin{matrix}SlopePer1\_ 2 = - 1 / 0.95 \approx - 1. 0526 \\ SlopePer2\_ 3 = - 1 / - 0.0735 \approx 13.617\end{matrix}$$

d) determining of the equations of the perpendicular bisectors for each line segment:

$$\begin{matrix}Y1\_ 2 - 31 = - 1 \text{.0526} * ( X - 60 ) \\ Y2\_ 3 - 52.5 = 13.617 * ( X - 46 )\end{matrix}$$

e) Setting the equations of the perpendicular bisectors equal to each other and solving them for x:

$$Xcenter\_point = ( SlopePer1\_ 2 * Ymidpoint1\_ 2 - SlopePer2\_ 3 * Ymidpoint2\_ 3 + Xmidpoint2\_ 3 - Xmidpoint1\_ 2 ) / ( SlopePer1\_ 2 - SlopePer2\_ 3 )$$

$$Xcenter\_point = ( SlopePer2\_ 3 * Ymidpoint2\_ 3 - SlopePer1\_ 2 * Ymidpoint1\_ 2 + Xmidpoint1\_ 2 - Xmidpoint2\_ 3 ) / ( SlopePer2\_ 3 - SlopePer1\_ 2 )$$

$$Xcenter\_point = ( - 1.0526 * 31 - 13.617 * 52.5 + 46 - 60 ) / ( - 1.0526 - 13.617 ) ) \approx 13.243$$

$$Xcenter\_point \approx 51.9116$$

f) Substitute the x-coordinate into one of the perpendicular bisector equations to find the corresponding y-coordinate:

$$Ycenter\_point = SlopePer1\_ 2 * ( Xcenter\_point - Xmidpoint1\_ 2 ) + Ymidpoint1\_ 2$$

$$Ycenter\_point = - 1.0526 * ( 51.9 \; 116 - 60 ) + 31 \approx 39.5138$$

$$Ycenter\_point \approx 39.9933$$

Accordingly, the intersection point (center) of the perpendicular bisectors is approximately (51.91, 39.99), which represents the center of the circle that coincides with the given points (40, 12), (80, 50), and (12, 55).

As indicated above, the intersection points defining the center of circle C′ may vary between images due to rotation of the impeller. In that case, the present technique may repeat the process using three center locations C′ determined based on three images using the same initial features P1-P3, thus determining center of the impeller. Accordingly monitoring of the position of the center of the impeller is done by repeating THE above processing continuously.

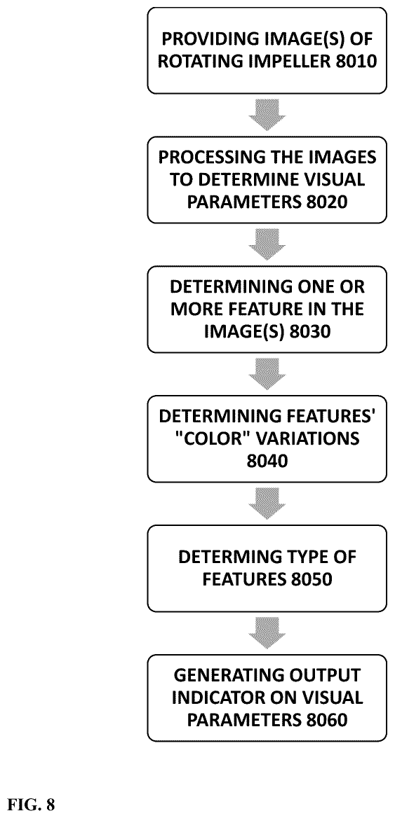

As also indicated above, monitoring of the rotating impeller may also include detection of one or more visual parameters of the impeller. Reference is made to FIG. 8 exemplifying a method for monitoring rotating impeller for visual parameters according to some embodiments of the present disclosure such as operation in an impeller analysis mode. As shown, the method includes providing one or more images of a rotating impeller 8010. To determine visual parameters, the one or more images are preferably obtained using relatively short exposure time as defined above. More specifically, the one or more images may be collected using exposure time sufficiently short to determine one or more distinguishable features of the impeller, similarly as described with references to FIG. 6B and FIGS. 7B to 7E. The method may further operate to process the one or more images for determining one or more visual parameters 8020. Generally, the processing may use any type of image processing technique, may relate to polychromatic images (e.g., RGB or other color images) or monochromatic images, and may utilize machine learning techniques. In some embodiments, the processing may include determining one or more features defined by color and/or intensity variations between pixels 8030. Each so-determine feature may be associated with structural element of the impeller and “color” defined by actual color and/or relative intensity distribution of one or more marks or feature(s) 8040. Based on for example spatial structure and “color” of the features, the processing may determine type of the features 8050. For example, a feature may be defined as a “blade”, “axle”, etc. Additionally, features associated with discoloring and unexpected intensity variation within a structural feature may be determined as deviations from normal structure. Such deviations may be associated with rust, corrosion, fractures, cracks, or other visual deviations of the impeller. The method may further include generating an output indicator of visual parameters, including details at least of abnormal visual parameters associated with variations in visibility of the impeller 8060. In some embodiments, the image processing may include comparison to pre-store previous images of the impeller if exist, or to pre-stored images of impeller blueprint to determine variations.

Accordingly, as described above, embodiments of the present disclosure provide a system and method for monitoring a rotating impeller, turbine, turbo condenser, or any other fast rotating element. As described above, the term impeller is used herein for simplicity and relates to the rotating element. Such impeller may include one or more blades or wings and may operate to push air from an intake, side to an outtake side thereof.

The system of embodiments of the present disclosure may include one or more optical imagers, and may include additional lighting arrangement to provide illumination and imaging conditions providing image data of the rotating impeller, and a processing utility, method and/or computer program, suitable for processing the collected images to determine one or more health indicators of the impeller as defined above.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hercinbefore described without departing from its scope, defined in and by the appended claims.

1. A system for monitoring a rotating impeller, the system comprising:
at least one optical imager positioned at a selected distance from the rotating impeller to provide one or more images of the rotating impeller; and
a controller operatively connected to said at least one optical imager and configured to operate the at least one optical imager for collecting one or more images of said rotating impeller, to enable analysis of the one or more images for providing indication of one or more health indicators of said rotating impeller.

2. The system of claim 1, wherein said at least one imager is positioned at intake side of said rotating impeller and comprises an aerodynamic housing to reduce disturbance to air flow.

3. The system of claim 1, wherein said at least one optical imager is positioned with optical axis thereof substantially parallel to rotation axis of said impeller and field of view of said at least one imager is substantially centered on rotation axis of said impeller.

4. The system of claim 1, wherein said at least one imager is operable with frame rate of up to 240 frames per second.

5. The system of claim 1, wherein said controller is connectable to at least one processor and memory circuitry configured for receiving and processing said one or more images and determining said one or more health indicators of said rotating impeller.

6. The system of claim 5, wherein said one or more health indicators include at least one of rust and corrosion of said rotating impeller.

7. The system of claim 1, further comprising a lighting arrangement comprises one or more light sources arranged along a peripheral housing of said impeller at a selected distance from the rotating impeller, said lighting arrangement is connectable to said controller and configured to be operable to provide strobing illumination of selected pulse duration, thereby determining said selected exposure duration for collection of said one or more images to provide imaging conditions for detection of one or more parameters of said rotating impeller.

8. The system of claim 7, wherein said controller is adapted for operating in a rotating frequency mode comprising operating said lighting arrangement to provide a first strobing pulse duration resulting in a selected level of blurring in collected images and to determine rotation speed of said rotating impeller in accordance with length of blurred features of said impeller.

9. The system of claim 7, wherein said controller is adapted to determine rotation speed based on a relation between duration of illumination pulse and angular range of blurred features in one or more collected images of said rotating impeller.

10. The system of claim 7, wherein said controller is adapted to determine said first strobing pulse duration in accordance with blur level of one or more features in one or more collected images, providing that blur level being associated with a rotation angle β<360°.

11. The system of claim 7, wherein said controller is adapted for operating in an impeller balance mode comprising operating said lighting arrangement to provide a second strobing pulse duration resulting in collection of one or more substantially sharp images, and for processing said one or more substantially sharp images to determine misalignment level of said rotating impeller.

12. The system of claim 11, wherein said processing comprises determining three or more reference indicators of said rotating impeller in said one or more collected images, and determining center of rotation of said impeller in accordance with location of said three or more reference indicators in said one or more collected images.

13. A method for monitoring a rotating impeller, comprising:
a. providing one or more images of a rotating impeller, said one or more images being collected with selected exposure duration;
b. processing said one or more images and determining one or more health indicators of said rotating impeller.

14. The method of claim 13, comprising determining rotation speed of said rotating impeller based on a relation between duration of illumination pulse and length of blurred features in one or more images of said rotating impeller.

15. The method of claim 13, wherein said processing comprises determining a relation between center of said impeller and axis of rotation thereof, and generating an output indicator on said relative distance.

16. The method of claim 13, further comprising providing one or more images of a first exposure duration, and processing said one or more images to determining angular range of blurring of one or more features of the impeller, and selecting a second exposure duration in accordance with desired angular range of blurring of said one or more features.

17. The method of claim 13, further comprising:
a. operating at least one optical imager positioned for imaging said rotating impeller, and a lighting arrangement positioned to illuminate said rotating impeller in synchronization to provide one or more images of selected exposure duration;
b. processing said one or more images and determining in accordance with exposure duration thereof one or more health indicators of said rotating impeller.

18. The method of claim 17, wherein said at least one optical imager is positioned at a selected distance from the rotating impeller where optical axis of said optical imager substantially coincides with axis of rotation of said rotating impeller.

19. A processing unit comprising at least one processor and memory circuitry configured for processing one or more images of at least a portion of a rotating impeller during operation and determining one or more health indicators of said rotating impeller; wherein said one or more health indicators comprise indication on one or more failure modes or trend of failure modes of the impeller.

20. The processing unit of claim 19, wherein said one or more failure modes or trend of failure comprise at least one of: a change in rotation speed, a change in relation between rotation speed and desired rotation speed, a change in impeller center location, a decentration of the impeller, a level of balance of the impeller, a lack of alignment between elements or one or more visual features of the impeller such as rust, corrosion, a crack, crack propagation, a fracture, a visual defect, bending, wear, leakage, a change in color, a change in appearance or change in pattern.
